(19) United States
(12) Patent Application Publication
(10) Pub. No.: US 2023/0377339 A1
(43) Pub. Date: Nov. 23, 2023

(54) PROCESSING FRAMEWORK FOR TEMPORAL-CONSISTENT FACE MANIPULATION IN VIDEOS

(71) Applicant: Adobe Inc., San Jose, CA (US)

(72) Inventors: Han GUO, San Jose, CA (US); Kshitiz GARG, Santa Clara, CA (US); Ali AMINIAN, San Jose, CA (US); Aashish MISRAA, San Jose, CA (US); William MARINO, Hockessin, DE (US); Nicolas HUYNH THIEN, San Francisco, CA (US)

(73) Assignee: Adobe Inc., San Jose, CA (US)

(21) Appl. No.: 17/751,322

(22) Filed: May 23, 2022

(51) Int. Cl. G06V 20/40; G06V 10/774; G06V 40/16; G06T 11/60

(52) U.S. Cl. CPC G06V 20/46; G06V 10/774; G06V 40/169; G06T 11/60

(57) ABSTRACT

Embodiments are disclosed for generating temporally consistent manipulated videos. A method of generating temporally consistent manipulated videos comprises receiving a target appearance and an input digital video including a plurality of frames, generating a plurality of target appearance frames from the plurality of frames, training a video prediction network to generate a digital video wherein a subject of the digital video has its appearance modified to match the target appearance, providing the input digital video to the video prediction network, and generating, by the video prediction network, an output digital video wherein the subject of the output digital video has its appearance modified to match the target appearance.

### BACKGROUND

Deep generative models have proven to be effective at producing realistic images from randomly sampled seeds. These models, such as generative adversarial networks (“GANs”), provide for photorealistic image generation of various objects, such as faces. These networks further allow for the controlled manipulation of existing digital images. For example, the expression, gaze, or other features of a face may be modified using such networks. While there are a number of networks that perform well for such image manipulation, they fail when used to attempt video manipulation.

A digital video comprises a plurality of frames. Individually applying existing image manipulation techniques to each frame requires expertise and often manual curation and editing of individual frames. For all that effort, the end result is still unsatisfactory. Although each individual frame may capture the intended changes to the image, they are not temporally consistent. This leads to significant visual artifacts, such as flickering. As a result, existing techniques are not able to adequately generate manipulated video.

### SUMMARY

Introduced here are techniques/technologies that generate temporally consistent manipulated videos in an automated manner. The system provides an image manipulation model-agnostic framework which can be used with any state-of-the-art model. Initially, frame level targeted appearance changes are obtained using the image manipulation model (e.g., a generator such as the one from StyleGAN, or other state-of-the-art model). This results in a set of target appearance frames in which the subject depicted in the video (e.g., a face or other object) has been modified to have a new appearance. In the example of faces, this may include changing the expression, gaze, hair, age, lighting, etc.

Using the target appearance frames and the input video, an encoder-decoder network is trained to post-process the target appearance frames to enforce temporal consistency. Once trained, the network can receive the cropped subjects from the original input video, and output corresponding manipulated subject crops, which are later blended back to the original input video. This results in a manipulated output video in which the subject now has the target appearance, which remains consistent across frames. This eliminates or greatly reduces flickering and other visual artifacts that may be introduced by the manipulation process when applied only to each frame individually.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of temporally consistent video manipulation in accordance with one or more embodiments;

FIG. 2 illustrates a diagram of generating target appearance frames in accordance with one or more embodiments;

FIG. 3 illustrates a diagram of an architecture for performing temporally consistent video manipulation in accordance with one or more embodiments;

FIG. 4 illustrates a diagram of a process for generating a temporally consistent manipulated video in accordance with one or more embodiments;

FIG. 5 illustrates a diagram of an architecture for generating a temporally consistent subject crops in accordance with one or more embodiments;

FIG. 6 illustrates a diagram of a user interface for generating a temporally consistent manipulated video in accordance with one or more embodiments;

FIG. 7 illustrates a schematic diagram of a video manipulation system in accordance with one or more embodiments;

FIG. 8 illustrates a flowchart of a series of acts in a method of temporally consistent video manipulation in accordance with one or more embodiments;

FIG. 9 illustrates a schematic diagram of an exemplary environment in which the image processing system can operate in accordance with one or more embodiments; and

FIG. 10 illustrates a block diagram of an exemplary computing device in accordance with one or more embodiments.

### DETAILED DESCRIPTION

One or more embodiments of the present disclosure include a video prediction network that has been trained to generate temporally consistent video with one or more modified target features. For example, for an input video that depicts a person's face, the video prediction network can generate an output video in which the person's facial appearance has been modified in one or more ways. As discussed, techniques exist to modify the appearance of object in an image. However, simply applying these techniques to all of the frames of a video generates unappealing results. This is due to a lack of temporal consistency from one modified frame to the next, which typically manifests as flickering during playback. Embodiments address these and other issues with prior techniques to generate a visually appealing modified video with minimal user input required.

In some embodiments, the user provides a digital video they want to modify. The term “digital video” refers to digital data representative of a sequence of visual images. In particular, a digital video includes a sequence of images which may include corresponding digital audio. For example, the term “digital video” includes, but is not limited to, digital files having one of the following file extensions: AVI, FLV, WMV, MOV, MP4. Similarly, as used herein, the term “frame” (or “frame of a digital video”) refers to a digital image from a digital video. The term “image” or “digital image” refers to a digital graphics file that when rendered displays one or more objects. In particular, the term “image” comprises a digital file that, when rendered, includes visual representations of one or more objects, such as a person. For example, the term “digital image” includes, but is not limited to, digital files with the following file extensions: JPG, TIFF, BMP, PNG, RAW, or PDF. Thus, a digital image includes digital data or a digital file for an image that is displayable via a graphical user interface of a display of a computing device. In some embodiments, an image refers to a frame of a digital video.

After the digital video has been provided, a representative frame of the digital video is shown to the user via a user interface. The user modifies the representative frame to achieve their desired appearance. As discussed further below, this may include interacting with the user interface to modify the appearance of an object depicted in the representative frame in one or more dimensions. The user's modifications are then applied to a plurality of the frames of the digital video to create a plurality of modified frames. The input video and the plurality of modified frames are then used to train a neural network to generate a temporally consistent modified video. Once trained, the neural network, or portions thereof, are used to generate a complete modified video for the input video.

This enables users to make photorealistic edits to subjects in videos without the artifacts introduced by prior techniques. Embodiments are discussed further with respect to manipulating different facial attributes in a video, such as age, facial hair, glasses, expression, etc., however embodiments are also applicable to different modifying different attributes of various subjects, not only faces. Not only do embodiments generate a temporal consistent video that lacks, or substantially reduces, the visual artifacts that are evident in prior techniques, it can also be performed quickly, using substantially fewer resources. For example, this enables amateur video editors to modify the appearance of the subject in a video to be shared with friends, as well as more advanced users to modify content to make changes to the subject's appearance instead of having to reset and capture subsequent takes of a professional or semi-professional video. Additionally, embodiments are agnostic as to which image-level model is used to generate the modified frames. This allows for embodiments to be used with any state-of-the-art model, which in turn improves the quality of the generated video.

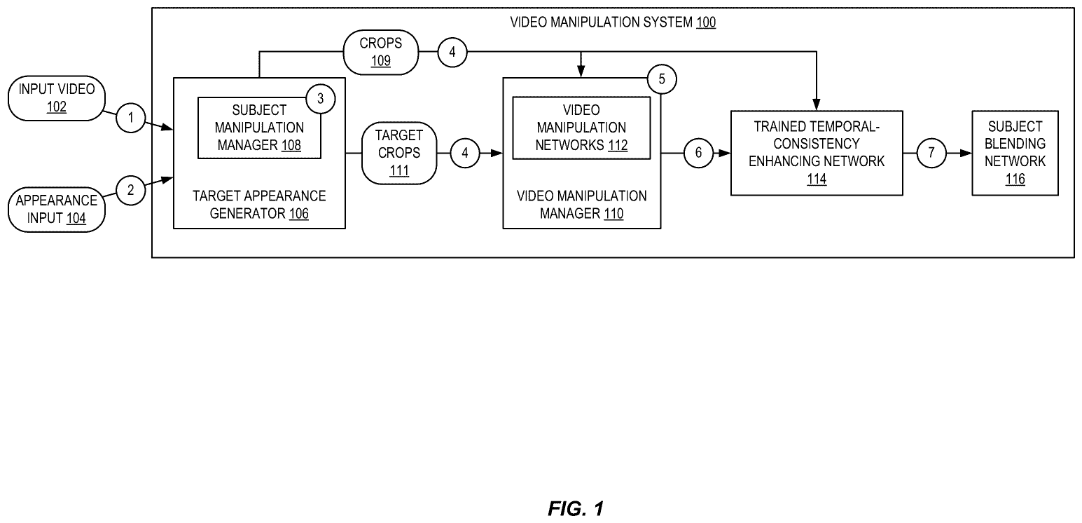

FIG. 1 illustrates a diagram of a process of temporally consistent video manipulation in accordance with one or more embodiments. As shown in FIG. 1, a video manipulation system 100 is provided which learns to generate a temporally consistent digital video which depicts a subject that has been modified based on user inputs. In the example of FIG. 1, an input video 102 is provided to the video manipulation system 100, at numeral 1. For example, a user may select an input video that is stored locally on a computing device on which the video manipulation system 100 is executing. Additionally, or alternatively, the input video 102 may be obtained from a remote system, such as a cloud storage system or storage service. In some embodiments, the input video 102 may be a portion of a larger digital video. For example, the input video 102 may be a clip that is selected by the user from a longer digital video.

The user chooses to manipulate the appearance of a subject of the input video 102. For example, where the subject of the input video 102 is a face, the user can choose to change the gaze, expression, age, hair, facial hair, glasses, or other facial features. If the subject is a different object, then the features of that object may be modified accordingly. In some embodiments, the appearance is modified based on an appearance input 104 received from the user at numeral 2. The appearance input 104 may be received through a user interface provided by the video manipulation system 100 and/or the target appearance generator 106.

The target appearance generator 106 includes a subject manipulation manager 108. As discussed further below, in some embodiments, the subject manipulation manager includes a subject cropping network, a subject manipulation network, and a subject blending network. For example, the input video 102 may include more than just the subject (e.g., the subject may be set in a larger scene). Accordingly, the subject may first be cropped from the video, resulting in a plurality of cropped images 109. A subject manipulation network 108 includes one or more machine learning models trained to generate an image with a modified appearance based on an input image. The subject manipulation network 108 can include any state-of-the art machine learning model or models capable of such modification. One such example includes a StyleGAN network, which has been trained to generate a new subject crop corresponding to an input subject crop in which the subject's appearance has been modified along one or more dimensions. For example, a subject manipulation network may be trained to alter the appearance of faces. In such an instance, it inverts the subject crop to determine a latent vector representation of the subject. The latent space can then be explored to find the vector that results in a manipulated image that achieves the desired appearance alterations (e.g., gaze, expression, hair, etc.).

At numeral 3, the subject manipulation manager 108 manipulates a plurality of frames of the input video 102 based on the appearance input 104. For example, the frames of the input video may first be cropped based on the subject of the frames. These cropped frames 109 are then input to the subject manipulation network of the subject manipulation manager 108. In some embodiments, the subject manipulation manager 108 is used to generate a manipulated frame corresponding to each frame of the input video 102. In some embodiments, the subject manipulation network performs manipulations on the cropped frames to generate target cropped frames 111. Alternatively, only a subset of manipulated frames is generated. For example, the user may select a specific clip or clips from the input video to be manipulated (such as those clips which include a representation of the subject to be manipulated). At numeral 4, the cropped subjects 109 from the input video and the target appearance subjects 111 generated by the subject manipulation manager 108 are provided to video manipulation manager 110.

The video manipulation manager 110 trains one or more video manipulation networks 112 based on the cropped subjects 109 from the input video 102 and the target appearance subjects 111 generated by the subject manipulation manager 108, at numeral 5. In various embodiments, the video manipulation networks 112 may include one or more neural networks, such as convolutional neural networks (CNNs), which learn to generate a set of temporally consistent manipulated crops, which are further blended to the input frames to generate an output video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

Once trained, a subset of the trained video manipulation networks 112 can be used as a temporal-consistency enhancing network 114, as shown at numeral 6. The trained temporal-consistency enhancing network 114 can then be provided with the subject crops 109 from the input video 102 and generate a set of manipulated subject crops which have been manipulated to have the desired appearance. Adding the temporal-consistency enhancing network 114 into the inference pipeline enables the generation of a set of temporally consistent manipulated subject crops, which lacks, or greatly reduces, the visual artifacts that are present when each subject crop is separately manipulated using traditional techniques. As shown at numeral 7, the manipulated subject crops are passed through a subject blending network 116. They are blended to the corresponding input frames in a seamless manner, which generates the final output video.

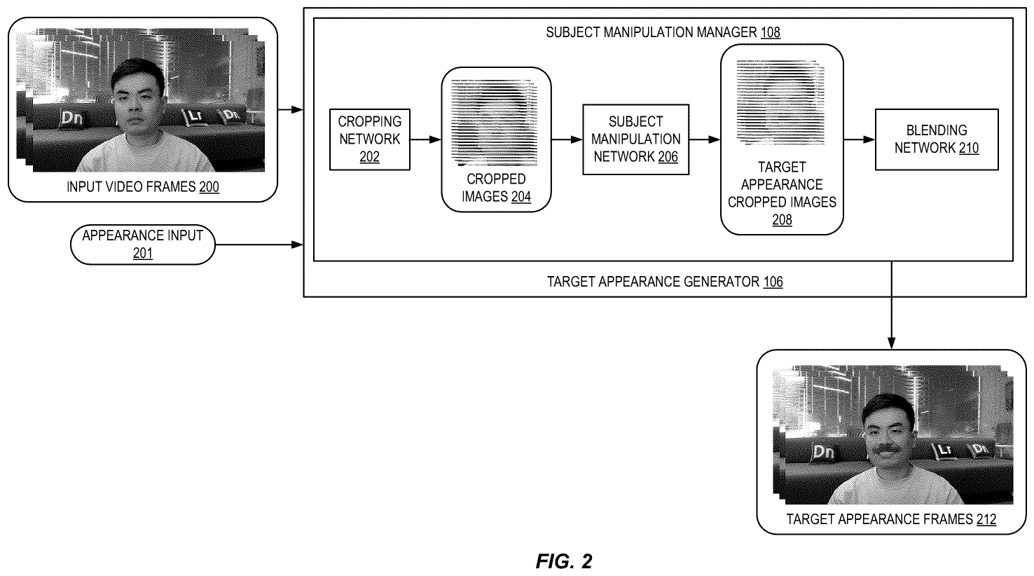

FIG. 2 illustrates a diagram of generating target appearance frames in accordance with one or more embodiments. As shown in FIG. 2, input video frames 200 may represent all or a portion of frames from a digital video, such as input digital video 102. In this instance, the input video frames 200 include a representation of a face, though various embodiments may also be used with frames depicting different subjects. The input video frames 200 are provided to target appearance generator 106. As shown, the target appearance generator 106 can include a cropping network 202, a subject manipulation network 206, and a blending network 210. The input video frames can be first processed by the cropping network 202. Cropping network 202 can include a neural network or other machine learning model trained to crop a particular subject. In the example of FIG. 2, the cropping network 202 is a face cropping network which has been trained to identify a face in image data and output a cropped image that includes the identified face. In some embodiments, the cropping network can process all input video frames first, to obtain a complete set of cropped images from the input video frames. Alternatively, the video frames may be processed serially, with each frame being completely processed by the subject manipulation manager 108 before the next frame is processed. In either instance, the cropped images 204 are then processed by subject manipulation network 206. Target appearance generator 106 then obtains appearance inputs 201 (e.g., provided by a user) to change the appearance of the subject of the input video frames. For example, one frame of the input video frames, or one cropped image, may be presented to a user via a user interface. The user may then manipulate the appearance of the subject using one or more user interface elements.

As discussed, the target appearance generator 106 may include one or more subject manipulation networks 206 that are used to generate a manipulated subject from an input subject crop. As discussed, the subject manipulation network 206 may include any state-of-the-art image manipulation model. Where multiple image manipulation models are used (for example, different models for different subjects, etc.), the models may include copies of the same model, trained to manipulate different subjects, and/or may include models having different model architectures which may be chosen based on their performance manipulated particular subject matter.

The subject manipulation network 206 then generates manipulated images corresponding to each of the cropped images 204, resulting in target appearance cropped images 208. Each target appearance cropped image 208 has had the same appearance manipulation settings received from the user for one frame (e.g., appearance input 201), applied to it. As a result, the subject has had its appearance altered in the same fashion in each target appearance cropped image 208. As discussed, one example of such manipulation is to invert the subject to identify a latent vector corresponding to the subject, explore the latent space to identify another vector that, when used to generate a new image, generates a manipulated target appearance cropped image that captures the desired appearance, and then blend back the target appearance cropped image to the frame with blending network 210, resulting in target appearance frames 212. In the example of FIG. 2, the appearance of the subject of input video frames 200 has been manipulated to add facial hair. In various embodiments, the blending network 210 can include a neural network or other machine learning model trained to blend a subject into a larger image. For example, in this example, the blending network 210 is a face blending network trained to blend a modified face into an image including a different face.

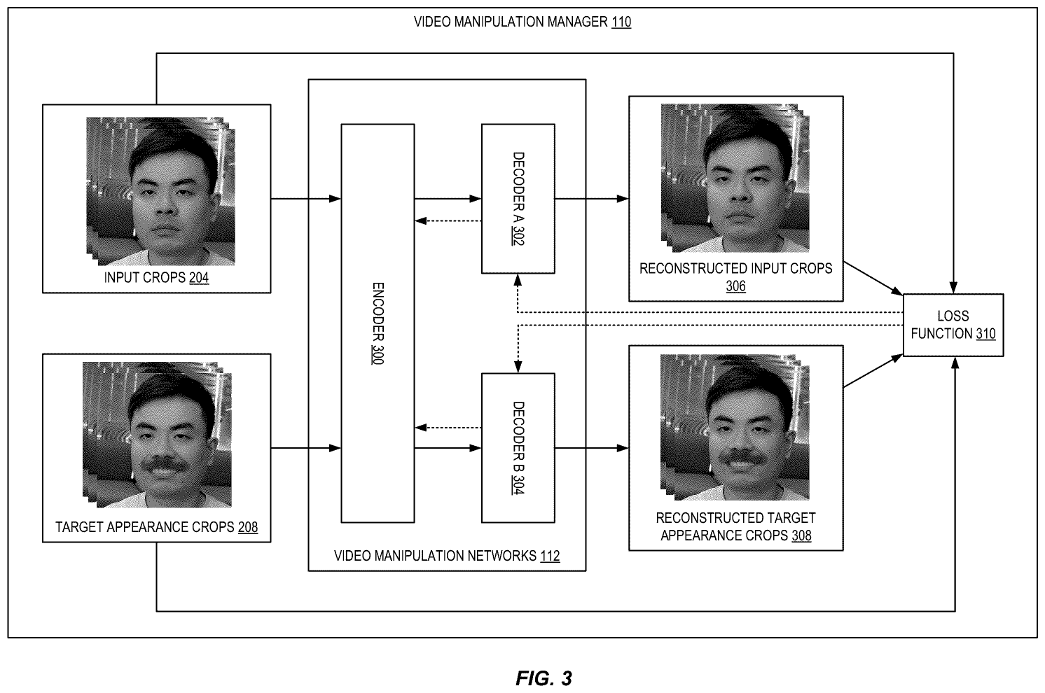

FIG. 3 illustrates a diagram of an architecture for performing temporally consistent video manipulation in accordance with one or more embodiments. As discussed, the input subject crops 124 and the target appearance crops 124 are used to train one or more video manipulation networks 112. In the example of FIG. 3, the video manipulation networks 112 include an encoder network 300 and two decoder networks: decoder A 302 and decoder B 304. In various embodiments, the encoder and decoder networks are implemented as neural networks, such as convolutional neural networks. Alternatively, in some embodiments, the video manipulation networks 112 include two encoder networks, one corresponding to decoder A 302 and one corresponding to decoder B 304. The two encoder networks may be copies of the same encoder network having the same encoder architecture or may be different encoder networks with different architectures.

The encoder 300 receives the input subject crops 204 and the target appearance crops 208 and the decoder networks learn to generate reconstructed versions of the input subject crops and the target appearance crops. The encoder 300 receives the input crops 204 and generates an encoded representation of the input crops. For example, an input crop is processed by encoder 300 which generates a corresponding encoded representation of that input crop. As is understood, the encoded representation may be an embedding, vector, or other data that represents the input frame. In the example of FIG. 3, the encoded representation is a latent face, which is a lower dimensional representation of the face crop passed through the encoder 300. That is, a latent face A is generated by passing an input face crop to the encoder and similarly a latent face B is generated by passing a target appearance crop to the encoder. Decoder A 302 then receives the encoded representations of the input crops and reconstructs the input video crops 306 from the encoded representations. Subsequently, the target appearance crops 124 are provided to the encoder 300, which generates an encoded representation of each target appearance frame. These are then used by decoder B 304 to reconstruct the target appearance crops 308. For example, the latent face A and latent face B are passed through decoder A and decoder B respectively to reconstruct the input face crop and the target appearance crop.

Training is then performed using one or more loss functions 310. As shown, the loss function 310 receives the reconstructed input subject crops 306 and input subject crops 122 and calculates a reconstruction loss. This loss is backpropagated to decoder A 302 and encoder 300. Similarly, the loss function 310 receives the reconstructed target crops 308 and target appearance crops 124 and calculates a reconstruction loss between these crops. This loss is backpropagated to decoder B 304 and encoder 300. The encoder 300 and decoders 302, 304 update their weights based on the loss. This process may be repeated until the models have converged (e.g., the reconstruction loss is below a threshold). As such, during training the encoder 300 and the decoders 302, 304 learn (e.g., by updating their weights) how to map a face to a low-dimensional representation such that when it is passed through the two decoders, two different faces can be reconstructed. This means the encoder 300 is learning to identify common features in both sets of face crops. In some embodiments, the loss function 310 is the weighted sum of two loss terms—DSSIM (structural dissimilarity) and MSE (mean squared error). In some embodiments, training may include a discriminator network that compares the input video frames and target appearance frames to their reconstructed counterparts. The encoder and decoders may then be trained based on whether the discriminator network can corrected distinguish between the frames and/or the loss function.

In various embodiments, the encoder 300 and decoders 302, 304 can be implemented as in other computer vision applications. For example, a structure of the encoder can be a concatenation of a convolutional layer (e.g., output size 128), a convolutional layer (e.g., output size 256), a convolutional layer (e.g., output size 512), a convolutional layer (e.g., output size 128), a dense layer, a reshape layer and an upscale layer (e.g., output size 128). A structure of the decoder can be a concatenation of an upscale layer (e.g., output size 256), an upscale layer (e.g., output size 128), an upscale layer (e.g., output size 64) and a convolutional layer. However, the encoder and decoders may be structured differently depending on implementation needs, performance considerations, etc.

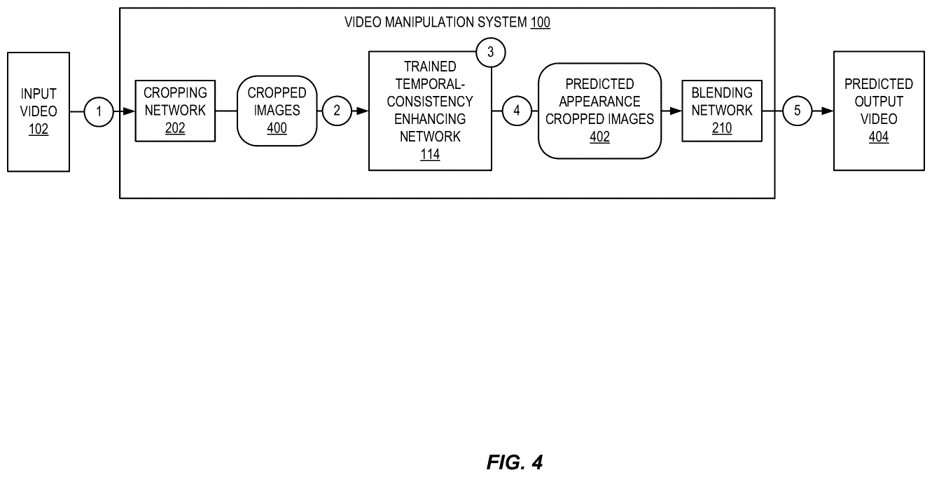

FIG. 4 illustrates a diagram of a process for generating a temporally consistent manipulated video in accordance with one or more embodiments. Once the networks have been trained, as discussed above, the trained temporal-consistency enhancing network 114 is ready to generate a set of temporally consistent output subject crops from the input subject crops. As shown in FIG. 4, at numeral 1, the input video 102 is provided to the cropping network 202. As discussed, cropping network 202 generates subject crops from the input video frames. For example, if the cropping network is a face cropping network, then for a given frame of the input video 102, a face crop is generated for the subject face in the input frame. Following that, at numeral 2, the cropped images 400 are provided to the temporal-consistency enhancing network 114. The temporal-consistency enhancing network 114 can be hosted as part of video manipulation system 100 or may be hosted in a different system or service.

At numeral 3, the trained temporal-consistency enhancing network 114 processes the input cropped images 400 to generate predicted output crops 400. Input face crops 122 are the same image crops that were used to train the temporal-consistency enhancing network 114, as discussed above. As noted, the temporal-consistency enhancing network may include all or some of the models trained as part of the video manipulation networks. Prediction time proceeds similarly to training time. Each cropped image is processed by the temporal-consistency enhancing network 114 at numeral 3, which then outputs predicted appearance cropped images 402. Each predicted output crop 402 is then provided to blending network 210, at numeral 4, to be blended back to the input frames by the blending network 210. This process is repeated for each frame of the input video. In some embodiments, the process is repeated for only a subset of frames of the input video that depict the subject being manipulated. Once the entire input video 102 has been processed, the result is predicted output video 404 which includes the subject having a manipulated appearance in a temporally consistent video.

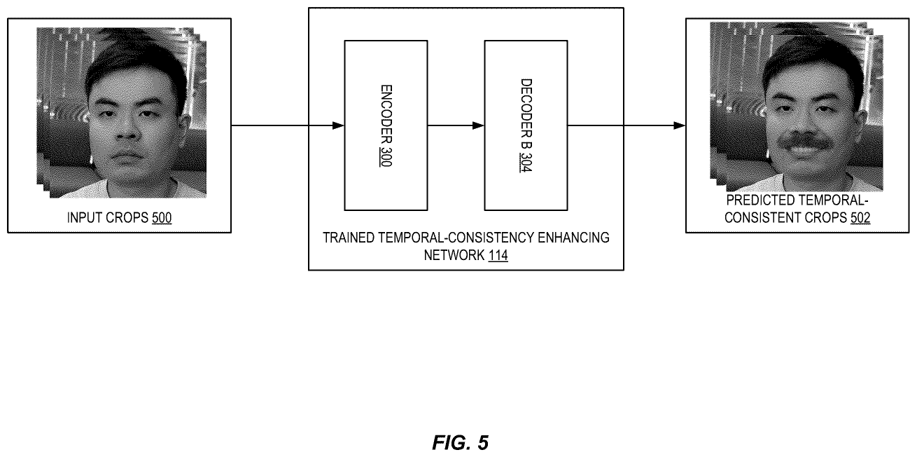

FIG. 5 illustrates a diagram of an architecture for generating a set of temporally consistent manipulated subject crops in accordance with one or more embodiments. As shown in FIG. 5, the trained temporal-consistency enhancing network 114 may include the encoder 300 and decoder B 304 that were trained as part of video manipulation networks 112. The encoder 300 generates, for each input crop 500, a low-dimensional representation which is passed to decoder B 304. As discussed above, decoder B 304 was trained to reconstruct manipulated crops from an encoded representation of the input crops. As a result, the decoder 304 produces predicted output crops 400 which have been manipulated in appearance to match the target appearance on which it was originally trained. In doing so, decoder B 304 produces a set of temporally consistent output subject crops, which lacks or greatly reduces the visual artifacts (e.g., flickering) present in prior techniques.

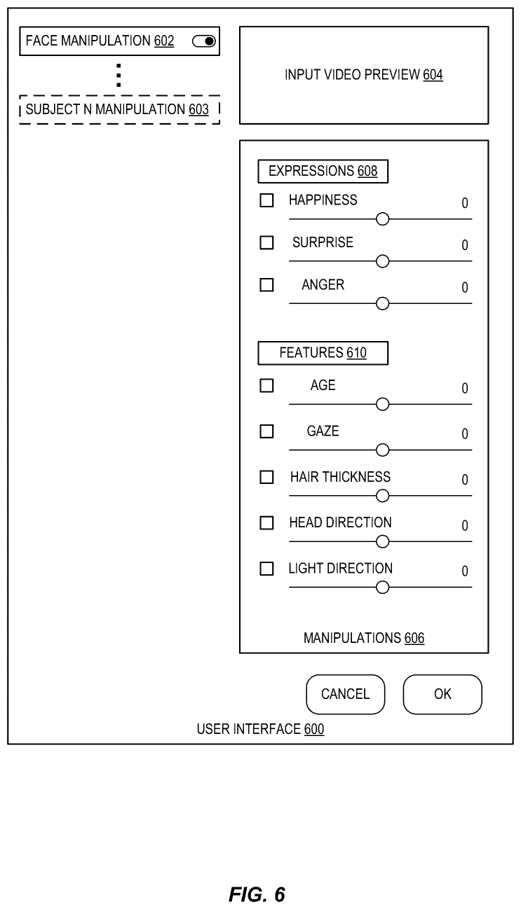

FIG. 6 illustrates a diagram of a user interface for generating a temporally consistent manipulated video in accordance with one or more embodiments. User interface 600 is one example of a user interface that may be used to generate temporally consistent manipulated videos, as discussed. The user interface 600 may include one or more options for the type of subject being manipulated. In this example, the face manipulation 602 option is selected, though the system may support a plurality of different subjects (e.g., to subject N manipulation 603) which may be selected, depending on the type of subject of the input video. In some embodiments, the cropping network identifies the subject and one or more manipulations available for that subject are presented to the user.

This user interface may be displayed upon selection of an input video. The user interface 600 can include a preview of the input video 604 which includes a representative frame, a clip, or other portion of the input video. The user can then choose from one or more manipulations 606 to apply to the subject of the input video and which are then displayed in the input video preview 604. In this example, the user may choose to alter the expressions 608 and/or features 610 of the subject face depicted in the input video. As shown, this may include happiness, surprise, anger, age, gaze, hair thickness, head direction, light direction, etc. In some embodiments, there are more or fewer manipulations available to the user. The provided manipulation settings can be used by any state-of-the-art image manipulation technique, such as StyleGAN or other models, to generate a manipulated image from a representative frame. This single image result is then shown to the user via the input video preview frame. In some embodiments, a subject crop corresponding to a frame of the input video is obtained from a cropping network and a manipulated subject crop is generated and presented to the user as a preview.

Once the desired manipulations are reflected in the input video preview 604, the user can select OK, and the techniques described herein are then applied to the input video. For example, the manipulations are used to generate target appearance frames for the input video and the input subject crops and target appearance crops are then used to train an encoder/decoder network. Once trained, the input video is provided to at least a portion of the trained encoder/decoder network to generate a temporally consistent manipulated output video.

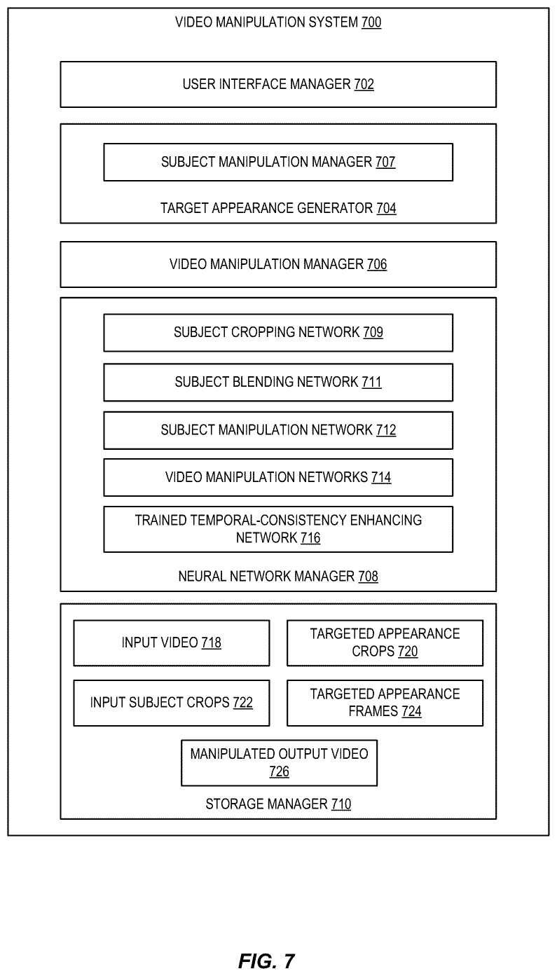

FIG. 7 illustrates a schematic diagram of video manipulation system (e.g., “video manipulation system” described above) in accordance with one or more embodiments. As shown, the video manipulation system 700 may include, but is not limited to, user interface manager 702, target appearance generator 704, video manipulation manager 706, neural network manager 708, and storage manager 710. The target appearance generator includes subject manipulation manager 707. The neural network manager 708 includes subject cropping network 709, subject blending network 711, subject manipulation network 712, video manipulation network 714, and trained temporal-consistency enhancing network 716. The storage manager 710 includes input video 718, targeted appearance crops 720, input subject crops 724 and manipulated output video 726.

As illustrated in FIG. 7, the video manipulation system 700 includes a user interface manager 702. For example, the user interface manager 702 allows users to provide input video data to the video manipulation system 700. In some embodiments, the user interface manager 702 provides a user interface through which the user can upload the input video 718 to be manipulated, as discussed above. Alternatively, or additionally, the user interface may enable the user to download the digital video from a local or remote storage location (for example, by providing an address (e.g., a URL or other endpoint) associated with the storage location). In some embodiments, the user interface can enable a user to link a video capture device, such as a camera or other hardware to capture video data and provide it to the video manipulation system 700.

Additionally, the user interface manager 702 allows users to request the video manipulation system 700 to manipulate the video data such as by changing the appearance of the subject depicted in the input video. For example, where the video data includes a representation of a person's face, the user can request that the video manipulation system change the age, hair or eye color, expression, hairstyle, facial hair, etc. In some embodiments, the user interface manager 702 enables the user to view the resulting manipulated video and/or request further edits to the video.

As illustrated in FIG. 7 the video manipulation system 700 also includes target appearance generator 704. As discussed, the target appearance generator uses a subject manipulation network 712 that is trained to change the appearance of an image. In some embodiments, the target appearance generator includes a subject manipulation manager 707 which is responsible for coordinating among multiple machine learning models to generate images having a targeted appearance. For example, the subject manipulation manager 707 can use a subject cropping network 709 to generate image crops showing just the subject from frames on an input video 718. These crops can then be provided to a subject manipulation network 712 to generate manipulated cropped images. As discussed, the subject manipulation network 712 can include any state-of-the-art model, such as StyleGAN or other machine learning models. The target appearance generator 704 receives appearance inputs from the user via user interface manager 702. The subject manipulation network 712 inverts the image to obtain the latent code that represents the image. The latent space can then be explored to identify the code that generates the appropriately modified image. The target appearance generator repeats this process for each crop of the input video to generate a plurality of target appearance crops 720. Further, a subject blending network 711 is used to blend the targeted appearance cropped images back into the input frames to create targeted appearance frames.

As illustrated in FIG. 7 the video manipulation system 700 also includes video manipulation manager 706. The video manipulation manager 706 can implement a training environment for one or more of the models hosted by neural network manager 708. The video manipulation manager 706 can teach, guide, tune, and/or train one or more neural networks. In particular, the video manipulation manager 706 can train a neural network based on a plurality of training data. For example, the video manipulation networks may be trained to generate a set of temporally consistent manipulated output crops where the appearance of the crops have been altered based on user inputs, as discussed above. More specifically, the video manipulation manager 706 can access, identify, generate, create, and/or determine training input and utilize the training input to train and fine-tune a neural network. For instance, the video manipulation manager 706 can train the models, end-to-end, as discussed above.

As illustrated in FIG. 7, the video manipulation system 700 also includes a neural network manager 708. Neural network manager 708 may host a plurality of neural networks or other machine learning models, such as subject cropping network 709, subject blending network 711, subject manipulation network 712, video manipulation networks 714, and temporal-consistency enhancing network 716. The neural network manager 708 may include an execution environment, libraries, and/or any other data needed to execute the machine learning models. In some embodiments, the neural network manager 708 may be associated with dedicated software and/or hardware resources to execute the machine learning models. As discussed, the subject manipulation network 712 can be implemented as any state-of-the-art network, such as StyleGAN or other generators. As discussed, the video manipulation networks 714 and the trained temporal-consistency enhancing network 716 may include encoder/decoder models. For example, the video manipulation networks 714 can include an encoder and two decoders which are trained to reconstruct subject crops of a digital video and corresponding target appearance crops from an encoded representation of these crops. Once trained, the encoder and one of the decoders can be used as the trained temporal-consistency enhancing network 716 to generate the manipulated output video 726 (by blending the output crops to the input frames), as discussed.

Although depicted in FIG. 7 as being hosted by a single neural network manager 708, in various embodiments the neural networks may be hosted in multiple neural network managers and/or as part of different components. For example, each model 714-716 can be hosted by their own neural network manager, or other host environment, in which the respective neural networks execute, or the models may be spread across multiple neural network managers depending on, e.g., the resource requirements of each model, etc.

As illustrated in FIG. 7, the video manipulation system 700 also includes the storage manager 710. The storage manager 710 maintains data for the video manipulation system 700. The storage manager 710 can maintain data of any type, size, or kind as necessary to perform the functions of the video manipulation system 700. The storage manager 710, as shown in FIG. 7, includes the input video 718. The input video 718 can include any digital video depicting a subject whose appearance can be modified by a subject manipulation network, as discussed in additional detail above. The input video 718 may include a plurality of frames that depict a subject to be manipulated. As discussed, the input frames can be processed by the subject cropping network 709 to produce input subject crops, which are modified versions of the input frames that have been cropped to depict the subject. In some embodiments, the subject cropping network may include a suite of applications or libraries that identify a subject in an input image. For example, in some embodiments Dlib is used as the subject cropping network. Alternative implementations may use different subject cropping networks depending on application.

As further illustrated in FIG. 7, the storage manager 710 also includes targeted appearance crops 720. Targeted appearance crops 720 correspond to the input subject crops 722 which have been processed based on user input to change the appearance of the subject. For example, the user indicates changes to be made to the appearance of a subject of the input video via user interface manager 702. As discussed, subject cropping network 709 is used to generate the input subject crops 722. This is followed by generating targeted appearance crops 720 by subject manipulation network 712 based on user input. The subject blending network 711 then blends the targeted appearance crops 720 into the frames of input video 718 to produce new frames (e.g., images) corresponding to each frame of the input video 718 in which the appearance of the subject has been modified. In some embodiments, the subject blending network may use Poisson blending, or other techniques, to blend the targeted appearance crops into the frames of the input video while minimizing visual artifacts such as seams. The input subject crops 722 and the targeted appearance crops 720 can then be used to train the video manipulation networks, as discussed. The storage manager 710 may also include manipulated output video 726. The manipulated output video 726 is the video produced by the trained temporal-consistency enhancing network 716, followed by the blending operation using subject blending network 711, when provided the input video 718. As discussed, the trained temporal-consistency enhancing network generates a temporally consistent manipulated set of subject crops. The crops are then blended back to the input frames to generate the output video, which applies the appearance changes to the subject without introducing flickering or other visual artifacts.

Each of the components 702-710 of the video manipulation system 700 and their corresponding elements (as shown in FIG. 7) may be in communication with one another using any suitable communication technologies. It will be recognized that although components 702-710 and their corresponding elements are shown to be separate in FIG. 7, any of components 702-710 and their corresponding elements may be combined into fewer components, such as into a single facility or module, divided into more components, or configured into different components as may serve a particular embodiment.

The components 702-710 and their corresponding elements can comprise software, hardware, or both. For example, the components 702-710 and their corresponding elements can comprise one or more instructions stored on a computer-readable storage medium and executable by processors of one or more computing devices. When executed by the one or more processors, the computer-executable instructions of the video manipulation system 700 can cause a client device and/or a server device to perform the methods described herein. Alternatively, the components 702-710 and their corresponding elements can comprise hardware, such as a special purpose processing device to perform a certain function or group of functions. Additionally, the components 702-710 and their corresponding elements can comprise a combination of computer-executable instructions and hardware.

Furthermore, the components 702-710 of the video manipulation system 700 may, for example, be implemented as one or more stand-alone applications, as one or more modules of an application, as one or more plug-ins, as one or more library functions or functions that may be called by other applications, and/or as a cloud-computing model. Thus, the components 702-710 of the video manipulation system 700 may be implemented as a stand-alone application, such as a desktop or mobile application. Furthermore, the components 702-710 of the video manipulation system 700 may be implemented as one or more web-based applications hosted on a remote server. Alternatively, or additionally, the components of the video manipulation system 700 may be implemented in a suit of mobile device applications or “apps.”

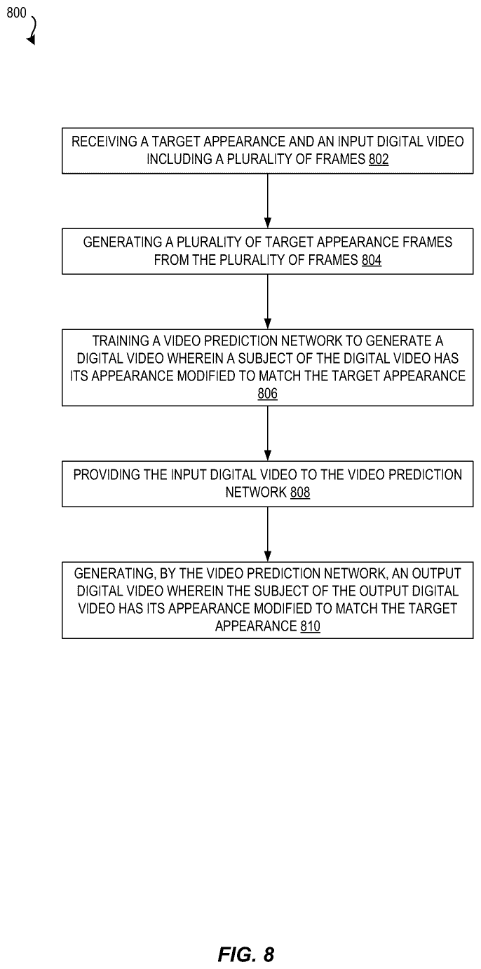

FIGS. 1-7, the corresponding text, and the examples, provide a number of different systems and devices that allows for generation of temporally consistent, manipulated videos. In addition to the foregoing, embodiments can also be described in terms of flowcharts comprising acts and steps in a method for accomplishing a particular result. For example, FIG. 8 illustrates a flowchart of an exemplary method in accordance with one or more embodiments. The method described in relation to FIG. 8 may be performed with fewer or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart 800 of a series of acts in a method of temporally consistent video manipulation in accordance with one or more embodiments. In one or more embodiments, the method 800 is performed in a digital medium environment that includes the video manipulation system 700. The method 800 is intended to be illustrative of one or more methods in accordance with the present disclosure and is not intended to limit potential embodiments. Alternative embodiments can include additional, fewer, or different steps than those articulated in FIG. 8.

As illustrated in FIG. 8, the method 800 includes an act 802 of receiving a target appearance and an input digital video including a plurality of frames. As noted, an input digital video may include a depiction of a subject, such as a face or other object. In some embodiments, the plurality of frames represents a subset of the input digital video. For example, the user may select all or a portion of the input video to be manipulated.

As illustrated in FIG. 8, the method 800 includes an act 804 generating a plurality of target appearance frames from the plurality of frames. As discussed, any state-of-the-art technique of image manipulation may be used to generate target appearance frames. In some embodiments, generating the target appearance frames includes providing the plurality of frames to a subject manipulation network, identifying a plurality of latent representations corresponding to the target appearance in the plurality of frames, and generating the plurality of target appearance frames using the plurality of latent representations. In some embodiments, the subject manipulation network is a generator network, such as StyleGAN.

As illustrated in FIG. 8, the method 800 includes an act 806 training a video prediction network to generate a digital video wherein a subject of the digital video has its appearance modified to match the target appearance. In some embodiments, the video prediction network is trained as part of a larger video manipulation network, which may include multiple encoders and/or decoders. For example, in some embodiments, training the video prediction network may include training a plurality of video manipulation networks, wherein the plurality of video manipulation networks include an encoder network, a first decoder network, and a second decoder network.

In some embodiments, training the plurality of video manipulation networks includes providing the plurality of frames and the plurality of target appearance frames to the encoder network, generating, by the encoder network, a representation of the plurality of frames and a representation of the plurality of target appearance frames, reconstructing, by the first decoder network, a plurality of reconstructed frames from the representation of the plurality of frames, reconstructing, by the second decoder network, a plurality of reconstructed target appearance frames from the representation of the plurality of target appearance frames, and training the first decoder network, second decoder network, and encoder network, by comparing the plurality of reconstructed frames to the plurality of frames and the plurality of reconstructed target appearance frames to the plurality of target appearance frames using a loss function.

As illustrated in FIG. 8, the method 800 includes an act 808 providing the input digital video to the video prediction network. In some embodiments, the video prediction network comprises the encoder network and the second decoder network. The video prediction network has been trained to generate a temporally consistent manipulated video which changes the appearance of the subject based on the user-specified target appearance.

As illustrated in FIG. 8, the method 800 includes an act 810 generating, by the video prediction network, an output digital video wherein the subject of the output digital video has its appearance modified to match the target appearance. In some embodiments, the subject of the input digital video includes a representation of a person's face and wherein the target appearance includes a change to an expression or appearance of the person's face.

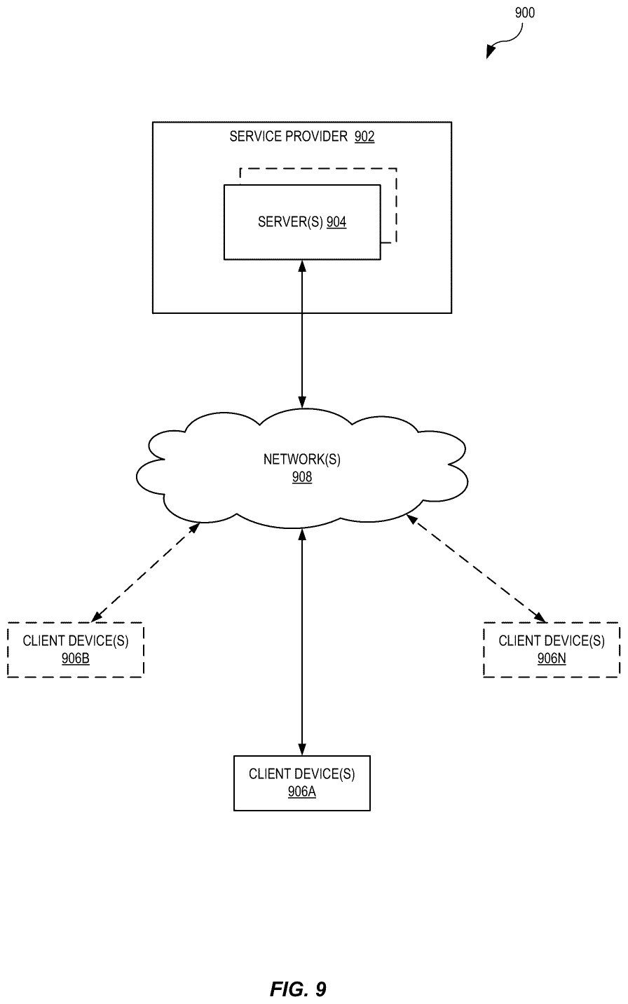

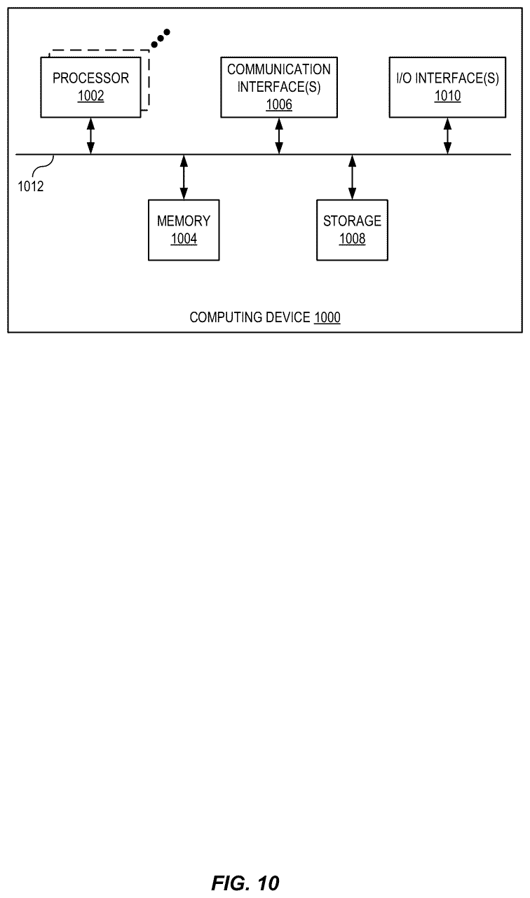

FIG. 9 illustrates a schematic diagram of an exemplary environment 900 in which the video manipulation system 700 can operate in accordance with one or more embodiments. In one or more embodiments, the environment 900 includes a service provider 902 which may include one or more servers 904 connected to a plurality of client devices 906A-906N via one or more networks 908. The client devices 906A-906N, the one or more networks 908, the service provider 902, and the one or more servers 904 may communicate with each other or other components using any communication platforms and technologies suitable for transporting data and/or communication signals, including any known communication technologies, devices, media, and protocols supportive of remote data communications, examples of which will be described in more detail below with respect to FIG. 10.

Although FIG. 9 illustrates a particular arrangement of the client devices 906A-906N, the one or more networks 908, the service provider 902, and the one or more servers 904, various additional arrangements are possible. For example, the client devices 906A-906N may directly communicate with the one or more servers 904, bypassing the network 908. Or alternatively, the client devices 906A-906N may directly communicate with each other. The service provider 902 may be a public cloud service provider which owns and operates their own infrastructure in one or more data centers and provides this infrastructure to customers and end users on demand to host applications on the one or more servers 904. The servers may include one or more hardware servers (e.g., hosts), each with its own computing resources (e.g., processors, memory, disk space, networking bandwidth, etc.) which may be securely divided between multiple customers, each of which may host their own applications on the one or more servers 904. In some embodiments, the service provider may be a private cloud provider which maintains cloud infrastructure for a single organization. The one or more servers 904 may similarly include one or more hardware servers, each with its own computing resources, which are divided among applications hosted by the one or more servers for use by members of the organization or their customers.

Similarly, although the environment 900 of FIG. 9 is depicted as having various components, the environment 900 may have additional or alternative components. For example, the environment 900 can be implemented on a single computing device with the video manipulation system 700. In particular, the video manipulation system 700 may be implemented in whole or in part on the client device 902A.

As illustrated in FIG. 9, the environment 900 may include client devices 906A-906N. The client devices 906A-906N may comprise any computing device. For example, client devices 906A-906N may comprise one or more personal computers, laptop computers, mobile devices, mobile phones, tablets, special purpose computers, TVs, or other computing devices, including computing devices described below with regard to FIG. 10. Although three client devices are shown in FIG. 9, it will be appreciated that client devices 906A-906N may comprise any number of client devices (greater or smaller than shown).

Moreover, as illustrated in FIG. 9, the client devices 906A-906N and the one or more servers 904 may communicate via one or more networks 908. The one or more networks 908 may represent a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. Thus, the one or more networks 908 may be any suitable network over which the client devices 906A-906N may access service provider 902 and server 904, or vice versa. The one or more networks 908 will be discussed in more detail below with regard to FIG. 10.

In addition, the environment 900 may also include one or more servers 904. The one or more servers 904 may generate, store, receive, and transmit any type of data. For example, a server 904 may receive data from a client device, such as the client device 906A, and send the data to another client device, such as the client device 902B and/or 902N. The server 904 can also transmit electronic messages between one or more users of the environment 900. In one example embodiment, the server 904 is a data server. The server 904 can also comprise a communication server or a web-hosting server. Additional details regarding the server 904 will be discussed below with respect to FIG. 10.

As mentioned, in one or more embodiments, the one or more servers 904 can include or implement at least a portion of the video manipulation system 700. In particular, the video manipulation system 700 can comprise an application running on the one or more servers 904 or a portion of the video manipulation system 700 can be downloaded from the one or more servers 904. For example, the video manipulation system 700 can include a web hosting application that allows the client devices 906A-906N to interact with content hosted at the one or more servers 904. To illustrate, in one or more embodiments of the environment 900, one or more client devices 906A-906N can access a webpage supported by the one or more servers 904. In particular, the client device 906A can run a web application (e.g., a web browser) to allow a user to access, view, and/or interact with a webpage or website hosted at the one or more servers 904.

Upon the client device 906A accessing a webpage or other web application hosted at the one or more servers 904, in one or more embodiments, the one or more servers 904 can provide access to one or more digital videos stored at the one or more servers 904. Moreover, the client device 906A can receive a request (i.e., via user input) to manipulate the appearance of a subject of the one or more digital videos and provide the request to the one or more servers 904. Upon receiving the request, the one or more servers 904 can automatically perform the methods and processes described above to generate temporally consistent manipulated videos. The one or more servers 904 can provide the resulting videos, to the client device 906A for display to the user.

As just described, the video manipulation system 700 may be implemented in whole, or in part, by the individual elements 902-908 of the environment 900. It will be appreciated that although certain components of the video manipulation system 700 are described in the previous examples with regard to particular elements of the environment 900, various alternative implementations are possible. For instance, in one or more embodiments, the video manipulation system 700 is implemented on any of the client devices 906A-N. Similarly, in one or more embodiments, the video manipulation system 700 may be implemented on the one or more servers 904. Moreover, different components and functions of the video manipulation system 700 may be implemented separately among client devices 906A-906N, the one or more servers 904, and the network 908.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an exemplary computing device 1000 that may be configured to perform one or more of the processes described above. One will appreciate that one or more computing devices such as the computing device 1000 may implement the image processing system. As shown by FIG. 10, the computing device can comprise a processor 1002, memory 1004, one or more communication interfaces 1006, a storage device 1008, and one or more I/O devices/interfaces 1010. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1008 and decode and execute them. In various embodiments, the processor(s) 1002 may include one or more central processing units (CPUs), graphics processing units (GPUs), field programmable gate arrays (FPGAs), systems on chip (SoC), or other processor(s) or combinations of processors.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1004 may be internal or distributed memory.

The computing device 1000 can further include one or more communication interfaces 1006. A communication interface 1006 can include hardware, software, or both. The communication interface 1006 can provide one or more interfaces for communication (such as, for example, packet-based communication) between the computing device and one or more other computing devices 1000 or one or more networks. As an example and not by way of limitation, communication interface 1006 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can comprise hardware, software, or both that couples components of computing device 1000 to each other.

The computing device 1000 includes a storage device 1008 includes storage for storing data or instructions. As an example, and not by way of limitation, storage device 1008 can comprise a non-transitory storage medium described above. The storage device 1008 may include a hard disk drive (HDD), flash memory, a Universal Serial Bus (USB) drive or a combination these or other storage devices. The computing device 1000 also includes one or more input or output (“I/O”) devices/interfaces 1010, which are provided to allow a user to provide input to (such as user strokes), receive output from, and otherwise transfer data to and from the computing device 1000. These I/O devices/interfaces 1010 may include a mouse, keypad or a keyboard, a touch screen, camera, optical scanner, network interface, modem, other known I/O devices or a combination of such I/O devices/interfaces 1010. The touch screen may be activated with a stylus or a finger.

The I/O devices/interfaces 1010 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1010 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving a target appearance and an input digital video including a plurality of frames;
generating a plurality of target appearance frames from the plurality of frames;
training a video prediction network to generate a digital video wherein a subject of the digital video has its appearance modified to match the target appearance;
providing the input digital video to the video prediction network; and
generating, by the video prediction network, an output digital video wherein the subject of the output digital video has its appearance modified to match the target appearance.

2. The method of claim 1, wherein the plurality of frames represents a subset of the input digital video.

3. The method of claim 1, wherein generating a plurality of target appearance frames from the plurality of frames, further comprises:
processing the plurality of frames by a subject cropping network to generate a plurality of input cropped images.

4. The method of claim 3, further comprising:
providing the plurality of input cropped images to a subject manipulation network;
identifying a plurality of latent representations corresponding to the target appearance in the plurality of input cropped images; and
generating a plurality of target appearance cropped images using the plurality of latent representations.

5. The method of claim 4, further comprising:
blending the plurality of target appearance cropped images and the plurality of frames using a subject blending network to generate the plurality of target appearance frames.

6. The method of claim 1, wherein training a video prediction network to generate a digital video wherein a subject of the digital video has its appearance modified to match the target appearance, further comprises:
training a plurality of video manipulation networks, wherein the plurality of video manipulation networks include an encoder network, a first decoder network, and a second decoder network.

7. The method of claim 6, wherein training a plurality of video manipulation networks, wherein the plurality of video manipulation networks include an encoder network, a first decoder network, and a second decoder network, further comprises:
providing the plurality of frames and the plurality of target appearance frames to the encoder network;
generating, by the encoder network, a representation of the plurality of frames and a representation of the plurality of target appearance frames;
reconstructing, by the first decoder network, a plurality of reconstructed frames from the representation of the plurality of frames;
reconstructing, by the second decoder network, a plurality of reconstructed target appearance frames from the representation of the plurality of target appearance frames; and
training the first decoder network, second decoder network, and encoder network, by comparing the plurality of reconstructed frames to the plurality of frames and the plurality of reconstructed target appearance frames to the plurality of target appearance frames using a loss function.

8. The method of claim 6, wherein the video prediction network comprises the encoder network and the second decoder network.

9. The method of claim 1, wherein a subject of the input digital video includes a representation of a person's face and wherein the target appearance includes a change to an expression or appearance of the person's face.

10. A non-transitory computer-readable storage medium including instructions stored thereon which, when executed by at least one processor, cause the at least one processor to:
receive a target appearance and an input digital video including a plurality of frames;
generate a plurality of target appearance frames from the plurality of frames;
train a video prediction network to generate a digital video wherein a subject of the digital video has its appearance modified to match the target appearance;
provide the input digital video to the video prediction network; and
generate, by the video prediction network, an output digital video wherein the subject of the output digital video has its appearance modified to match the target appearance.

11. The non-transitory computer-readable storage medium of claim 10, wherein the plurality of frames represents a subset of the input digital video.

12. The non-transitory computer-readable storage medium of claim 10, wherein to generate a plurality of target appearance frames from the plurality of frames, the instructions, when executed, further cause the at least one processor to:
process the plurality of frames by a subject cropping network to generate a plurality of input cropped images.

13. The non-transitory computer-readable storage medium of claim 12, wherein the instructions, when executed, further cause the at least one processor to:
provide the plurality of input cropped images to a subject manipulation network;
identify a plurality of latent representations corresponding to the target appearance in the plurality of input cropped images; and
generate a plurality of target appearance cropped images using the plurality of latent representations.

14. The non-transitory computer-readable storage medium of claim 13, wherein the instructions, when executed, further cause the at least one processor to:
blend the plurality of target appearance cropped images and the plurality of frames using a subject blending network to generate the plurality of target appearance frames.

15. The non-transitory computer-readable storage medium of claim 10, wherein to train a video prediction network to generate a digital video wherein a subject of the digital video has its appearance modified to match the target appearance, the instructions, when executed, further cause the at least one processor to:
train a plurality of video manipulation networks, wherein the plurality of video manipulation networks include an encoder network, a first decoder network, and a second decoder network.

16. The non-transitory computer-readable storage medium of claim 15, wherein to train a plurality of video manipulation networks, wherein the plurality of video manipulation networks include an encoder network, a first decoder network, and a second decoder network, the instructions, when executed, further cause the at least one processor to:
provide the plurality of frames and the plurality of target appearance frames to the encoder network;
generate, by the encoder network, a representation of the plurality of frames and a representation of the plurality of target appearance frames;
reconstruct, by the first decoder network, a plurality of reconstructed frames from the representation of the plurality of frames;
reconstruct, by the second decoder network, a plurality of reconstructed target appearance frames from the representation of the plurality of target appearance frames; and
train the first decoder network, second decoder network, and encoder network, by comparing the plurality of reconstructed frames to the plurality of frames and the plurality of reconstructed target appearance frames to the plurality of target appearance frames using a loss function.

17. The non-transitory computer-readable storage medium of claim 15, wherein the video prediction network comprises the encoder network and the second decoder network.

18. The non-transitory computer-readable storage medium of claim 10, wherein a subject of the input digital video includes a representation of a person's face and wherein the target appearance includes a change to an expression or appearance of the person's face.

19. A system comprising:
a memory component; and
a processing device coupled to the memory component, the processing device to execute instructions stored on the memory component which cause the system to perform operations comprising:
generating a plurality of target appearance frames corresponding to an input digital video based on an appearance input defining a target appearance of a subject of the input digital video;
training a video prediction network using the plurality of target appearance frames and the input digital video;
providing the input digital video to the video prediction network; and
generating, by the video prediction network, a temporally consistent output digital video wherein the subject of the temporally consistent output digital video has its appearance modified to match the target appearance.

20. The system of claim 19, wherein the plurality of frames represents a subset of the input digital video.
